(19) United States
(12) Patent Application Publication
(10) Pub. No.: US 2026/0089510 A1
(43) Pub. Date: Mar. 26, 2026

(54) Zero trust mobile network-as-a-service

(71) Applicant: Zscaler, Inc., San Jose, CA (US)

(72) Inventors: Daan Huybregts, Amsterdam (NL); Nathan Howe, San Jose, CA (US); Ken Urquhart, San Jose, CA (US)

(73) Assignee: Zscaler, Inc., San Jose, CA (US)

(21) Appl. No.: 18/893,419

(22) Filed: Sep. 23, 2024

(51) Int. Cl. H04W 12/121

(52) U.S. Cl. CPC H04W 12/121

(57) ABSTRACT

Systems and methods for a zero trust mobile network-as-a-service include generating one or more virtualized mobile networks for one or more customers of a cloud service; receiving traffic from a Subscriber Identity Module (SIM) enabled device associated with a customer of the cloud service; steering the traffic through a virtualized mobile network based on the customer associated with the SIM enabled device; and applying zero trust policy to the traffic prior to the traffic exiting the virtualized mobile network.

### FIELD OF THE DISCLOSURE

The present disclosure generally relates to network and cloud security. More particularly, the present disclosure relates to systems and methods for zero trust mobile network-as-a-service.

### BACKGROUND OF THE DISCLOSURE

Mobile or cellular networks are structured to provide extensive connectivity services. When a SIM card is activated, it grants the processor of the SIM access to a set of authorized services, at a network level, enabling connectivity from the SIM device either to the Internet or a designated private path. While this system facilitates data communication, it inherently lacks active security measures for protecting these communications. As a result, any malicious entity, whether an individual, organization, or government, with network access or the capability to reroute a SIM to a different network plane (for example, through international roaming, IMSI catchers, or similar techniques), can potentially intercept, redirect the traffic and control all traffic to and from the SIM-based device. This security gap allows attackers to misuse, capture, scrutinize, and alter the content, path, and destination of the communications. The absence of comprehensive security protocols at the network level leaves data vulnerable, underscoring the critical need for supplementary security solutions to protect communications from unauthorized access and interference.

### BRIEF SUMMARY OF THE DISCLOSURE

The present disclosure relates to systems and methods for zero trust mobile network-as-a-service. In various embodiments, the present disclosure includes a method having steps, a processing device configured to implement the steps, a cloud-based system configured to implement the steps, and as a non-transitory computer-readable medium storing instructions for programming one or more processors to execute the steps. The steps include receiving traffic from a Subscriber Identity Module (SIM) enabled device associated with a customer of a cloud service; steering the traffic through a virtualized mobile network based on the customer associated with the SIM enabled device; and applying zero trust policy to the traffic prior to the traffic exiting the virtualized mobile network.

The steps can further include wherein the virtualized mobile network includes one or more virtualized components of a mobile network. The steps can include generating one or more virtualized mobile networks for one or more customers of the cloud service. Prior to the receiving, the steps can include provisioning the SIM of the SIM enabled device to a specific virtualized mobile network. The provisioning can include provisioning each of a plurality of SIMs of a plurality of devices to one of a plurality of specific virtualized mobile networks. Each of the plurality of specific virtualized mobile networks can be associated with a customer of the cloud service, wherein traffic from a device is navigated to a specific customer's virtualized mobile network based on the provisioning. Prior to the receiving, the steps can include distributing a cryptographic token to the SIM enabled device, wherein the SIM is adapted to store and use the cryptographic token as a point of trust validation throughout a connection to the virtualized mobile network.

### BRIEF DESCRIPTION OF THE DRAWINGS

The present disclosure is illustrated and described herein with reference to the various drawings, in which like reference numbers are used to denote like system components/method steps, as appropriate, and in which:

FIG. 1A is a network diagram of three example network configurations of cybersecurity monitoring and protection of a user.

FIG. 1B is a logical diagram of the cloud operating as a zero-trust platform.

FIG. 2 is a block diagram of a server.

FIG. 3 is a block diagram of a computing device.

FIG. 4 is a diagram of an exemplary network configuration illustrating an application on computing devices configured to operate through the cloud.

FIG. 5 is a diagram of an architecture delivering zero trust mobility-as-a-service.

FIG. 6 is a diagram representing three stages for providing zero trust mobile network-as-a-service.

FIG. 7 is a representation of 4G services that can be virtualized when necessary to deliver data plane connectivity.

FIG. 8 is a representation of 5G services that can be virtualized when necessary to deliver data plane connectivity.

FIG. 9 is a flow diagram of a data path through virtualized infrastructure.

FIG. 10 is a flow diagram of an embodiment of the functionality of the present zero trust mobile network-as-a-service.

FIG. 11 is a flowchart of a process for zero trust mobile network-as-a-service.

### DETAILED DESCRIPTION OF THE DISCLOSURE

Again, the present disclosure relates to systems and methods for zero trust mobile network-as-a-service. In various embodiments, the present systems provide a virtualized mobile network service for traffic originating from SIM enabled devices destined for mobile networks. By employing the present invention, customers can experience complete end to end control and protection of their mobile network traffic. In various embodiments, to achieve such end to end control, SIMs are provisioned to allow the systems to provide customer based virtualized networks, where customers can configure desired services and controls.

### § 1.0 CYBERSECURITY MONITORING AND PROTECTION EXAMPLES

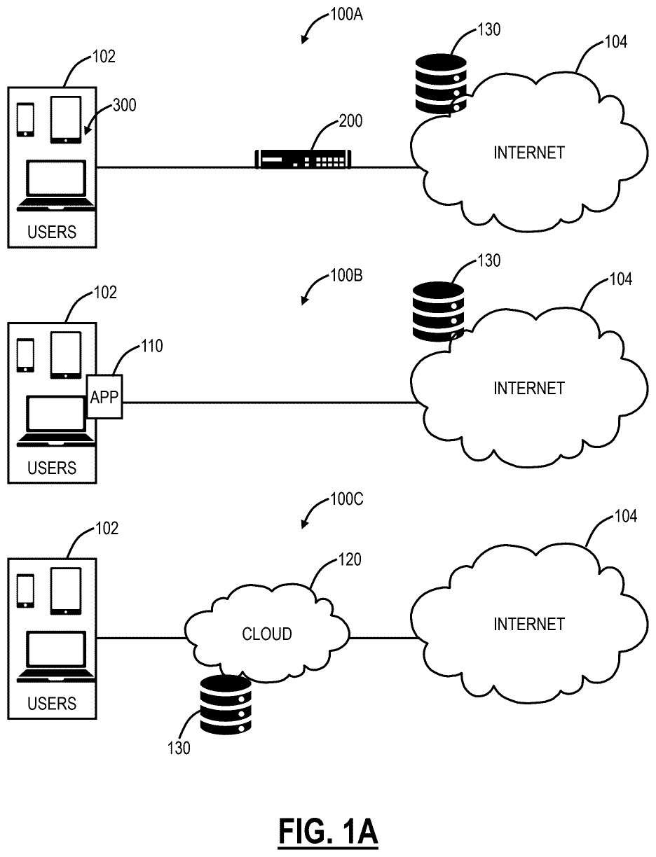

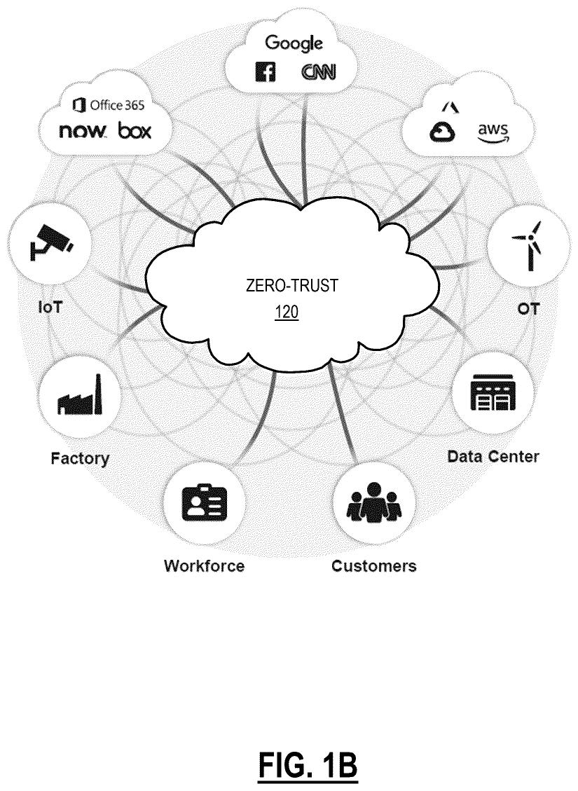

FIG. 1A is a network diagram of three example network configurations 100A, 100B, 100C of cybersecurity monitoring and protection of an endpoint 102. Those skilled in the art will recognize these are some examples for illustration purposes, there may be other approaches to cybersecurity monitoring (as well as providing generalized services), and these various approaches can be used in combination with one another as well as individually. Also, while shown for a single endpoint 102, practical embodiments will handle a large volume of endpoints 102, including multi-tenancy. In this example, the endpoint 102 communicates on the Internet 104, including accessing cloud services, Software-as-a-Service, etc. (each may be offered via computing resources, such as, e.g., using one or more servers 200 as illustrated in FIG. 2).

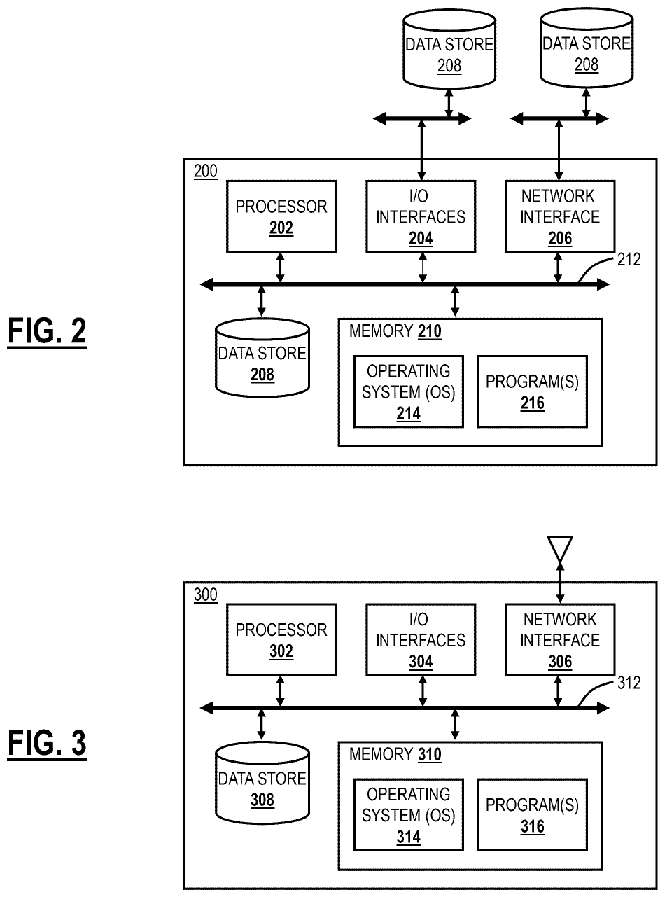

Note, the term endpoint 102 is used herein to refer to any computing device (see FIG. 3 for an example computing device 300) which can communicate on a network. The endpoint 102 can be associated with a user and include laptops, tablets, mobile phones, desktops, etc. Further, the endpoint can also mean machines, workloads, IoT devices, or simply anything associated with the company that connects to the Internet, a Local Area Network (LAN), etc.

As part of offering cybersecurity through these example network configurations 100A, 100B, 100C, there is a large amount of cybersecurity data obtained. Various embodiments of the present disclosure focus on using this cybersecurity data along with a customer's data to perform various security tasks including developing customer machine learning models and other security platforms of the like.

The network configuration 100A includes a server 200 located between the endpoint 102 and the Internet 104. For example, the server 200 can be a proxy, a gateway, a Secure Web Gateway (SWG), Secure Internet and Web Gateway, Secure Access Service Edge (SASE), Secure Service Edge (SSE), Cloud Application Security Broker (CASB), etc. The server 200 is illustrated located inline with the endpoint 102 and configured to monitor the endpoint 102. In other embodiments, the server 200 does not have to be inline. For example, the server 200 can monitor requests from the endpoint 102 and responses to the endpoint 102 for one or more security purposes, as well as allow, block, warn, and log such requests and responses. The server 200 can be on a local network associated with the endpoint 102 as well as external, such as on the Internet 104. Also, while described as a server 200, this can also be a router, switch, appliance, virtual machine, etc. The network configuration 100B includes an application 110 that is executed on the computing device 300. The application 110 can perform similar functionality as the server 200, as well as coordinated functionality with the server 200 (a combination of the network configurations 100A, 100B). Finally, the network configuration 100C includes a cloud service 120 configured to monitor the endpoint 102 and perform security-as-a-service. Of course, various embodiments are contemplated herein, including combinations of the network configurations 100A, 100B, 100C together.

The cybersecurity monitoring and protection can include firewall, intrusion detection and prevention, Uniform Resource Locator (URL) filtering, content filtering, bandwidth control, Domain Name System (DNS) filtering, protection against advanced threat (malware, spam, Cross-Site Scripting (XSS), phishing, etc.), data protection, sandboxing, antivirus, and any other security technique. Any of these functionalities can be implemented through any of the network configurations 100A, 100B, 100C. A firewall can provide Deep Packet Inspection (DPI) and access controls across various ports and protocols as well as being application and user aware. The URL filtering can block, allow, or limit website access based on policy for a user, group of users, or entire organization, including specific destinations or categories of URLs (e.g., gambling, social media, etc.). The bandwidth control can enforce bandwidth policies and prioritize critical applications such as relative to recreational traffic. DNS filtering can control and block DNS requests against known and malicious destinations.

The intrusion prevention and advanced threat protection can deliver full threat protection against malicious content such as browser exploits, scripts, identified botnets and malware callbacks, etc. The sandbox can block zero-day exploits (just identified) by analyzing unknown files for malicious behavior. The antivirus protection can include antivirus, antispyware, antimalware, etc. protection for the endpoints 102, using signatures sourced and constantly updated. The DNS security can identify and route command-and-control connections to threat detection engines for full content inspection. The DLP can use standard and/or custom dictionaries to continuously monitor the endpoints 102, including compressed and/or Transport Layer Security (TLS) or Secure Sockets Layer (SSL)-encrypted traffic.

In typical embodiments, the network configurations 100A, 100B, 100C can be multi-tenant and can service a large volume of the endpoints 102. Newly discovered threats can be promulgated for all tenants practically instantaneously. The endpoints 102 can be associated with a tenant, which may include an enterprise, a corporation, an organization, etc. That is, a tenant is a group of users who share a common grouping with specific privileges, i.e., a unified group under some IT management. The present disclosure can use the terms tenant, enterprise, organization, enterprise, corporation, company, etc. interchangeably and refer to some group of endpoints 102 under management by an IT group, department, administrator, etc., i.e., some group of endpoints 102 that are managed together. One advantage of multi-tenancy is the visibility of cybersecurity threats across a large number of endpoints 102, across many different organizations, across the globe, etc. This provides a large volume of data to analyze, use machine learning techniques on, develop comparisons, etc. The present disclosure can use the term “service provider” to denote an entity providing the cybersecurity monitoring and a “customer” as a company (or any other grouping of endpoints 102).

Of course, the cybersecurity techniques above are presented as examples. Those skilled in the art will recognize other techniques are also contemplated herewith. That is, any approach to cybersecurity that can be implemented via any of the network configurations 100A, 100B, 100C. Also, any of the network configurations 100A, 100B, 100C can be multi-tenant with each tenant having its own endpoints 102 and configuration, policy, rules, etc.

### § 1.1 Cloud Monitoring

The cloud 120 can scale cybersecurity monitoring and protection with near-zero latency on the endpoints 102. Also, the cloud 120 in the network configuration 100C can be used with or without the application 110 in the network configuration 100B and the server 200 in the network configuration 100A. Logically, the cloud 120 can be viewed as an overlay network between endpoints 102 and the Internet 104 (and cloud services, SaaS, etc.). Previously, the IT deployment model included enterprise resources and applications stored within a data center (i.e., physical devices) behind a firewall (perimeter), accessible by employees, partners, contractors, etc. on-site or remote via Virtual Private Networks (VPNs), etc. The cloud 120 replaces the conventional deployment model. The cloud 120 can be used to implement these services in the cloud without requiring the physical appliances and management thereof by enterprise IT administrators. As an ever-present overlay network, the cloud 120 can provide the same functions as the physical devices and/or appliances regardless of geography or location of the endpoints 102, as well as independent of platform, operating system, network access technique, network access provider, etc.

There are various techniques to forward traffic between the endpoints 102 and the cloud 120. A key aspect of the cloud 120 (as well as the other network configurations 100A, 100B) is that all traffic between the endpoints 102 and the Internet 104 is monitored. All of the various monitoring approaches can include log data 130 accessible by a management system, management service, analytics platform, and the like. For illustration purposes, the log data 130 is shown as a data storage element and those skilled in the art will recognize the various compute platforms described herein can have access to the log data 130 for implementing any of the techniques described herein for risk quantification. In an embodiment, the cloud 120 can be used with the log data 130 from any of the network configurations 100A, 100B, 100C, as well as other data from external sources.

The cloud 120 can be a private cloud, a public cloud, a combination of a private cloud and a public cloud (hybrid cloud), or the like. Cloud computing systems and methods abstract away physical servers, storage, networking, etc., and instead offer these as on-demand and elastic resources. The National Institute of Standards and Technology (NIST) provides a concise and specific definition which states cloud computing is a model for enabling convenient, on-demand network access to a shared pool of configurable computing resources (e.g., networks, servers, storage, applications, and services) that can be rapidly provisioned and released with minimal management effort or service provider interaction. Cloud computing differs from the classic client-server model by providing applications from a server that are executed and managed by a client's web browser or the like, with no installed client version of an application required. Centralization gives cloud service providers complete control over the versions of the browser-based and other applications provided to clients, which removes the need for version upgrades or license management on individual client computing devices. The phrase “Software-as-a-Service” (SaaS) is sometimes used to describe application programs offered through cloud computing. A common shorthand for a provided cloud computing service (or even an aggregation of all existing cloud services) is “the cloud.” The cloud 120 contemplates implementation via any approach known in the art.

The cloud 120 can be utilized to provide example cloud services, including Zscaler Internet Access (ZIA), Zscaler Private Access (ZPA), Zscaler Workload Segmentation (ZWS), and/or Zscaler Digital Experience (ZDX), all from Zscaler, Inc. (the assignee and applicant of the present application). Also, there can be multiple different clouds 120, including ones with different architectures and multiple cloud services. The ZIA service can provide the access control, threat prevention, and data protection. ZPA can include access control, microservice segmentation, etc. The ZDX service can provide monitoring of user experience, e.g., Quality of Experience (QoE), Quality of Service (QoS), etc., in a manner that can gain insights based on continuous, inline monitoring. For example, the ZIA service can provide a user with Internet Access, and the ZPA service can provide a user with access to enterprise resources instead of traditional Virtual Private Networks (VPNs), namely ZPA provides Zero Trust Network Access (ZTNA). Those of ordinary skill in the art will recognize various other types of cloud services are also contemplated.

### § 1.2 Zero Trust

FIG. 1B is a logical diagram of the cloud 120 operating as a zero-trust platform. Zero trust is a framework for securing organizations in the cloud and mobile world that asserts that no user or application should be trusted by default. Following a key zero trust principle, least-privileged access, trust is established based on context (e.g., user identity and location, the security posture of the endpoint, the app or service being requested) with policy checks at each step, via the cloud 120. Zero trust is a cybersecurity strategy where security policy is applied based on context established through least-privileged access controls and strict user authentication—not assumed trust. A well-tuned zero trust architecture leads to simpler network infrastructure, a better user experience, and improved cyberthreat defense.

Establishing a zero-trust architecture requires visibility and control over the environment's users and traffic, including that which is encrypted; monitoring and verification of traffic between parts of the environment; and strong multi-factor authentication (MFA) approaches beyond passwords, such as biometrics or one-time codes. This is performed via the cloud 120. Critically, in a zero-trust architecture, a resource's network location is not the biggest factor in its security posture anymore. Instead of rigid network segmentation, your data, workflows, services, and such are protected by software-defined micro segmentation, enabling you to keep them secure anywhere, whether in your data center or in distributed hybrid and multi-cloud environments.

The core concept of zero trust is simple: assume everything is hostile by default. It is a major departure from the network security model built on the centralized data center and secure network perimeter. These network architectures rely on approved IP addresses, ports, and protocols to establish access controls and validate what's trusted inside the network, generally including anybody connecting via remote access VPN. In contrast, a zero-trust approach treats all traffic, even if it is already inside the perimeter, as hostile. For example, workloads are blocked from communicating until they are validated by a set of attributes, such as a fingerprint or identity. Identity-based validation policies result in stronger security that travels with the workload wherever it communicates—in a public cloud, a hybrid environment, a container, or an on-premises network architecture.

Because protection is environment-agnostic, zero trust secures applications and services even if they communicate across network environments, requiring no architectural changes or policy updates. Zero trust securely connects users, devices, and applications using business policies over any network, enabling safe digital transformation. Zero trust is about more than user identity, segmentation, and secure access. It is a strategy upon which to build a cybersecurity ecosystem.

At its core are three tenets:
Terminate every connection: Technologies like firewalls use a “passthrough” approach, inspecting files as they are delivered. If a malicious file is detected, alerts are often too late. An effective zero trust solution terminates every connection to allow an inline proxy architecture to inspect all traffic, including encrypted traffic, in real time—before it reaches its destination—to prevent ransomware, malware, and more.
Protect data using granular context-based policies: Zero trust policies verify access requests and rights based on context, including user identity, device, location, type of content, and the application being requested. Policies are adaptive, so user access privileges are continually reassessed as context changes.
Reduce risk by eliminating the attack surface: With a zero-trust approach, users connect directly to the apps and resources they need, never to networks (see ZTNA). Direct user-to-app and app-to-app connections eliminate the risk of lateral movement and prevent compromised devices from infecting other resources. Plus, users and apps are invisible to the internet, so they cannot be discovered or attacked.

### § 1.3 Log Data

With the cloud 120 as well as any of the network configurations 100A, 100B, 100C, the log data 130 can include a rich set of statistics, logs, history, audit trails, and the like related to various endpoint 102 transactions. Generally, this rich set of data can represent activity by an endpoint 102. This information can be for multiple endpoints 102 of a company, organization, etc., and analyzing this data can provide a wealth of information as well as training data for machine learning models.

The log data 130 can include a large quantity of records used in a backend data store for queries. A record can be a collection of tens of thousands of counters. A counter can be a tuple of an identifier (ID) and value. As described herein, a counter represents some monitored data associated with cybersecurity monitoring. Of note, the log data can be referred to as sparsely populated, namely a large number of counters that are sparsely populated (e.g., tens of thousands of counters or more, and possible orders of magnitude or more of which are empty). For example, a record can be stored every time period (e.g., an hour or any other time interval). There can be millions of active endpoints 102 or more. Examples of the sparsely populated log data can be the Nanolog system from Zscaler, Inc., the applicant.

Also, such data is described in the following:
Commonly-assigned U.S. Pat. No. 8,429,111, issued Apr. 23, 2013, and entitled “Encoding and compression of statistical data,” the contents of which are incorporated herein by reference, describes compression techniques for storing such logs,
Commonly-assigned U.S. Pat. No. 9,760,283, issued Sep. 12, 2017, and entitled “Systems and methods for a memory model for sparsely updated statistics,” the contents of which are incorporated herein by reference, describes techniques to manage sparsely updated statistics utilizing different sets of memory, hashing, memory buckets, and incremental storage, and
Commonly-assigned U.S. patent application Ser. No. 16/851,161, filed Apr. 17, 2020, and entitled “Systems and methods for efficiently maintaining records in a cloud-based system,” the contents of which are incorporated herein by reference, describes compression of sparsely populated log data.

A key aspect here is that the cybersecurity monitoring is rich and provides a wealth of information to determine various assessments of cybersecurity. In some embodiments, the log data 130 can be referred to as weblogs or the like. Of note, with various cybersecurity monitoring techniques via the network configurations 100A, 100B, 100C, as well as with other network configurations, the log data 130 is a rich repository of endpoint 102 activity. Unlike websites, specific cloud services, application providers, etc., cybersecurity monitoring can log almost all of a user's 102 activity. That is, the log data 130 is not merely confined to specific activity (e.g., a user's 102 social networking activity on a specific site, a user's 102 search requests on a specific search engine, etc.).

### § 2.0 EXAMPLE SERVER ARCHITECTURE

FIG. 2 is a block diagram of a server 200, which may be used as a destination on the Internet, for the network configuration 100A, etc. The server 200 may be a digital computer that, in terms of hardware architecture, generally includes a processor 202, input/output (I/O) interfaces 204, a network interface 206, a data store 208, and memory 210. It should be appreciated by those of ordinary skill in the art that FIG. 2 depicts the server 200 in an oversimplified manner, and a practical embodiment may include additional components and suitably configured processing logic to support known or conventional operating features that are not described in detail herein. The components (202, 204, 206, 208, and 210) are communicatively coupled via a local interface 212. The local interface 212 may be, for example, but not limited to, one or more buses or other wired or wireless connections, as is known in the art. The local interface 212 may have additional elements, which are omitted for simplicity, such as controllers, buffers (caches), drivers, repeaters, and receivers, among many others, to enable communications. Further, the local interface 212 may include address, control, and/or data connections to enable appropriate communications among the aforementioned components.

The processor 202 is a hardware device for executing software instructions. The processor 202 may be any custom made or commercially available processor, a Central Processing Unit (CPU), an auxiliary processor among several processors associated with the server 200, a semiconductor-based microprocessor (in the form of a microchip or chipset), or generally any device for executing software instructions. When the server 200 is in operation, the processor 202 is configured to execute software stored within the memory 210, to communicate data to and from the memory 210, and to generally control operations of the server 200 pursuant to the software instructions. The I/O interfaces 204 may be used to receive user input from and/or for providing system output to one or more devices or components.

The network interface 206 may be used to enable the server 200 to communicate on a network, such as the Internet 104. The network interface 206 may include, for example, an Ethernet card or adapter or a Wireless Local Area Network (WLAN) card or adapter. The network interface 206 may include address, control, and/or data connections to enable appropriate communications on the network. A data store 208 may be used to store data. The data store 208 may include any volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 208 may incorporate electronic, magnetic, optical, and/or other types of storage media. In one example, the data store 208 may be located internal to the server 200, such as, for example, an internal hard drive connected to the local interface 212 in the server 200. Additionally, in another embodiment, the data store 208 may be located external to the server 200 such as, for example, an external hard drive connected to the I/O interfaces 204 (e.g., SCSI or USB connection). In a further embodiment, the data store 208 may be connected to the server 200 through a network, such as, for example, a network-attached file server.

The memory 210 may include any volatile memory elements (e.g., random access memory (RAM, such as DRAM, SRAM, SDRAM, etc.)), nonvolatile memory elements (e.g., ROM, hard drive, tape, CDROM, etc.), and combinations thereof. Moreover, the memory 210 may incorporate electronic, magnetic, optical, and/or other types of storage media. Note that the memory 210 may have a distributed architecture, where various components are situated remotely from one another but can be accessed by the processor 202. The software in memory 210 may include one or more software programs, each of which includes an ordered listing of executable instructions for implementing logical functions. The software in the memory 210 includes a suitable Operating System (O/S) 214 and one or more programs 216. The operating system 214 essentially controls the execution of other computer programs, such as the one or more programs 216, and provides scheduling, input-output control, file and data management, memory management, and communication control and related services. The one or more programs 216 may be configured to implement the various processes, algorithms, methods, techniques, etc. described herein. Those skilled in the art will recognize the cloud 120 ultimately runs on one or more physical servers 200, virtual machines, etc..

### § 3.0 EXAMPLE COMPUTING DEVICE ARCHITECTURE

FIG. 3 is a block diagram of a computing device 300, which may be realize an endpoint 102. Specifically, the computing device 300 can form a device used by one of the endpoints 102, and this may include common devices such as laptops, smartphones, tablets, netbooks, personal digital assistants, cell phones, e-book readers, Internet-of-Things (IoT) devices, servers, desktops, printers, televisions, streaming media devices, storage devices, and the like, i.e., anything that can communicate on a network. The computing device 300 can be a digital device that, in terms of hardware architecture, generally includes a processor 302, I/O interfaces 304, a network interface 306, a data store 308, and memory 310. It should be appreciated by those of ordinary skill in the art that FIG. 3 depicts the computing device 300 in an oversimplified manner, and a practical embodiment may include additional components and suitably configured processing logic to support known or conventional operating features that are not described in detail herein. The components (302, 304, 306, 308, and 302) are communicatively coupled via a local interface 312. The local interface 312 can be, for example, but not limited to, one or more buses or other wired or wireless connections, as is known in the art. The local interface 312 can have additional elements, which are omitted for simplicity, such as controllers, buffers (caches), drivers, repeaters, and receivers, among many others, to enable communications. Further, the local interface 312 may include address, control, and/or data connections to enable appropriate communications among the aforementioned components.

The processor 302 is a hardware device for executing software instructions. The processor 302 can be any custom made or commercially available processor, a CPU, an auxiliary processor among several processors associated with the computing device 300, a semiconductor-based microprocessor (in the form of a microchip or chipset), or generally any device for executing software instructions. When the computing device 300 is in operation, the processor 302 is configured to execute software stored within the memory 310, to communicate data to and from the memory 310, and to generally control operations of the computing device 300 pursuant to the software instructions. In an embodiment, the processor 302 may include a mobile-optimized processor such as optimized for power consumption and mobile applications. The I/O interfaces 304 can be used to receive user input from and/or for providing system output. User input can be provided via, for example, a keypad, a touch screen, a scroll ball, a scroll bar, buttons, a barcode scanner, and the like. System output can be provided via a display device such as a Liquid Crystal Display (LCD), touch screen, and the like.

The network interface 306 enables wireless communication to an external access device or network. Any number of suitable wireless data communication protocols, techniques, or methodologies can be supported by the network interface 306, including any protocols for wireless communication. The data store 308 may be used to store data. The data store 308 may include any volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 308 may incorporate electronic, magnetic, optical, and/or other types of storage media.

The memory 310 may include any volatile memory elements (e.g., random access memory (RAM, such as DRAM, SRAM, SDRAM, etc.)), nonvolatile memory elements (e.g., ROM, hard drive, etc.), and combinations thereof. Moreover, the memory 310 may incorporate electronic, magnetic, optical, and/or other types of storage media. Note that the memory 310 may have a distributed architecture, where various components are situated remotely from one another, but can be accessed by the processor 302. The software in memory 310 can include one or more software programs, each of which includes an ordered listing of executable instructions for implementing logical functions. In the example of FIG. 3, the software in the memory 310 includes a suitable operating system 314 and programs 316. The operating system 314 essentially controls the execution of other computer programs and provides scheduling, input-output control, file and data management, memory management, and communication control and related services. The programs 316 may include various applications, add-ons, etc. configured to provide end-user functionality with the computing device 300. For example, example programs 316 may include, but not limited to, a web browser, social networking applications, streaming media applications, games, mapping and location applications, electronic mail applications, financial applications, and the like. The application 110 can be one of the example programs.

### § 4.0 APPLICATION FOR TRAFFIC FORWARDING AND MONITORING

Again, the network configuration 100B includes an application 110 that is executed on the computing device 300. The application 110 can perform similar functionality as the server 200, as well as coordinated functionality with the server 200 (a combination of the network configurations 100A, 100B). Of course, various embodiments are contemplated herein, including combinations of the network configurations 100A, 100B, 100C together. For example, the application 110 can perform similar functionality as the cloud 120, as well as coordinated functionality with the cloud 120.

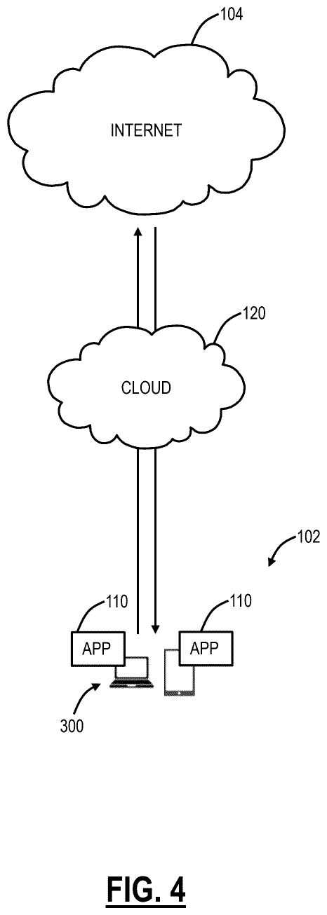

FIG. 4 is a network diagram of an exemplary network configuration illustrating an application 110 on computing devices 300 configured to operate through the cloud 120. Different types of computing devices 300 are proliferating, including Bring Your Own Device (BYOD) as well as IT-managed devices. The conventional approach for a computing device 300 to operate with the cloud 120 as well as for accessing enterprise resources includes complex policies, VPNs, poor user experience, etc. The application 110 can automatically forward user traffic with the cloud 120 as well as ensuring that security and access policies are enforced, regardless of device, location, operating system, or application. The application 110 automatically determines if a user 102 is looking to access the open Internet 104, a SaaS app, or an internal app running in public, private, or the datacenter and routes mobile traffic through the cloud 120. The application 110 can support various cloud services, including ZIA, ZPA, ZDX, etc., allowing the best in class security with zero trust access to internal applications. As described herein, the application 110 can also be referred to as a connector application.

The application 110 is configured to auto-route traffic for seamless user experience. This can be protocol as well as application-specific, and the application 110 can route traffic with a nearest or best fit node of the cloud 120. Further, the application 110 can detect trusted networks, allowed applications, etc. and support secure network access. The application 110 can also support the enrollment of the computing device 300 prior to accessing applications, the internet, or any services provided by the cloud 120. The application 110 can uniquely detect the users 102 based on fingerprinting the user device 300, using criteria like device model, platform, operating system, device posture, etc. The application 110 can support Mobile Device Management (MDM) functions, allowing IT personnel to deploy and manage the computing devices 300 seamlessly. This can also include the automatic installation of client and SSL certificates during enrollment. Finally, the application 110 provides visibility into device and app usage of the user 102 of the computing device 300.

The application 110 supports a secure, lightweight tunnel between the computing device 300 and the cloud 120. For example, the lightweight tunnel can be HTTP-based. With the application 110, there is no requirement for PAC files, an IPSec VPN, authentication cookies, or user 102 setup.

### § 5.0 ZERO TRUST MOBILE NETWORK-AS-A-SERVICE

The present invention delivers an end to end zero trust mobile network-as-a-service. Various embodiments provide protection for any Subscriber Identity Modules (SIM) enabled device over a dedicated mobile service solely for that entity. The present systems and methods for facilitating the zero trust mobile network-as-a-service include providing dedicated mobile service over the top of existing mobile networks. By providing such functionality, traffic can benefit from the protection and zero trust controls offered by the cloud 120 described herein applied from end to end.

Mobile or cellular networks have been designed to facilitate mass connectivity as a service. By activating a SIM card, users gain direct access to the granted services, which operate at a network level, providing connectivity either to the Internet or to a dedicated private network. This connectivity enables data communications but does not inherently provide active security for those communications. As a result, any malicious actor, entity, or government with access to the network or has the capability to redirect a SIM to another network plane (such as through roaming out of country, IMSI catchers, or other methods) and can gain full access to all traffic from that SIM-based device. This lack of protection allows such attackers to capture, inspect, and even manipulate the content of the communications. The absence of robust security measures at the network level leaves the data vulnerable, making it imperative for additional security solutions to be implemented to safeguard communications against unauthorized access and tampering.

Various embodiments of the present invention include spinning up a virtualized environment for a customer so that the customers mobile network is ultimately controlled and protected end to end by the security services provided by the cloud 120 described herein. The goal of the present systems is to deliver a zero trust exchange by extending control into the connectivity of devices from their SIMs. In various embodiments, virtualized mobile networks can be generated for specific groups of devices which belong to specific customers/entities. That is, as is further described herein, groups of SIMs can be identified and navigated to specific virtualized networks on a per-customer basis.

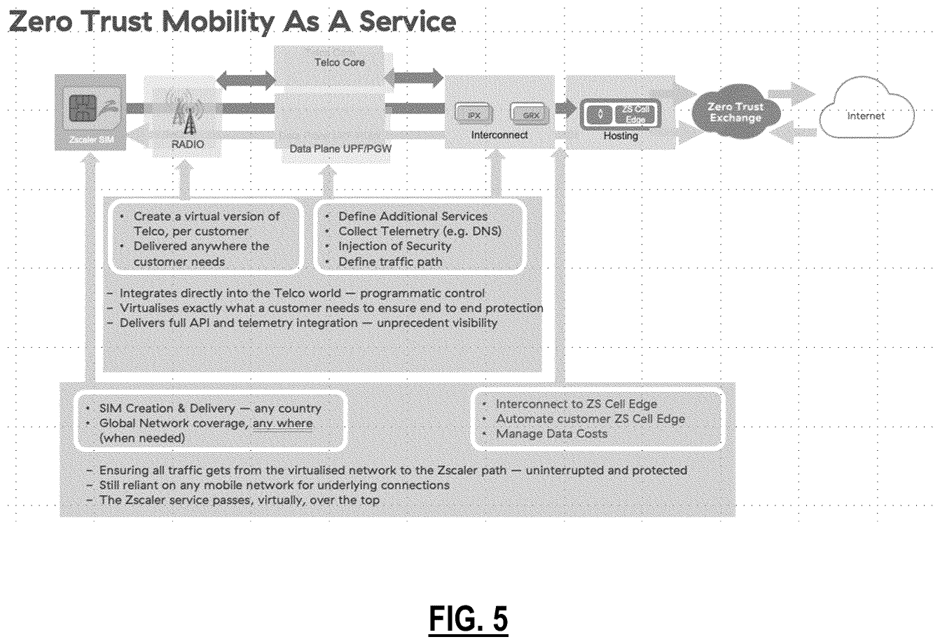

FIG. 5 is a diagram of an architecture for delivering zero trust mobility-as-a-service. Steps include deploying a SIM that is tagged as being an approved/allowed identified SIM that is able to connect to the environment. Based on this, after the approved SIM is identified, the systems are adapted to deliver the traffic to the correct location. To take the process even further than simply providing a SIM and a bolt on egress security product, the present systems and methods take it further by virtualizing all of the internal components/infrastructure that are necessary and traditionally created and managed by telecommunications companies, but now on a per customer basis. In addition, the systems also provide a virtualized data plane where specific customer defined mobile infrastructure is created. This can be integrated into the mobile network such that when a SIM sends traffic, it hits the control plane on the mobile level that is specifically built for the customer.

That is, various embodiments include SIM creation and delivery to any geographic region for global network coverage. This ensures that all traffic can get from the SIM device, through the virtualized network to the appropriate path in the cloud 120. In various embodiments, this process is reliant on any mobile network for underlying connections. The present service passes virtually over the top of these mobile networks. The virtual mobile network itself is created as a virtual version of a telecommunications network on a per-customer basis. By doing so, the virtual mobile network can be delivered anywhere the customer needs it. Further, the virtual mobile network can define additional services, i.e., the various security services described herein, collect telemetry, inject security, and define traffic paths. These systems and methods are designed to directly integrate into the telecommunications world with programmatic control. By virtualizing exactly what the customer needs, end to end protection of customer traffic can be provided.

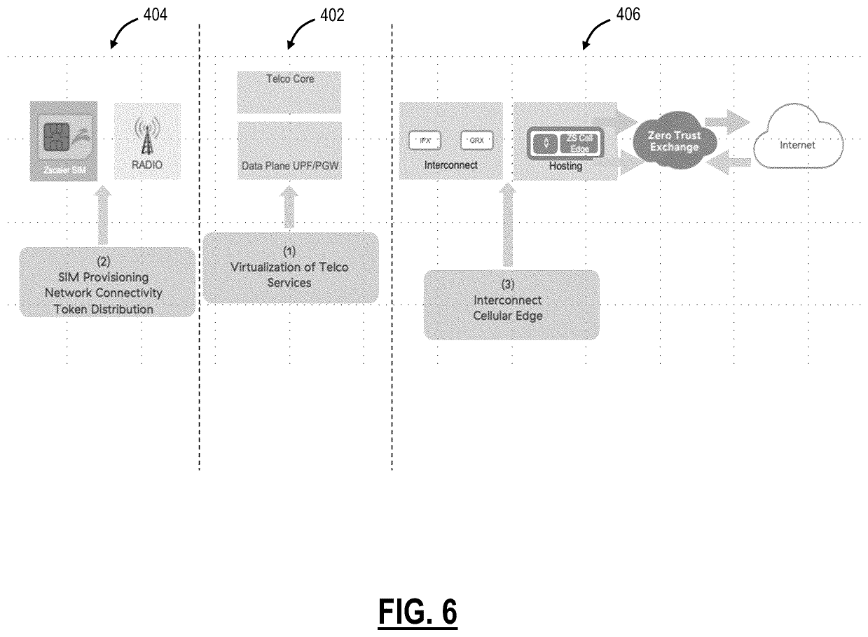

More particularly, various embodiments include provisioning a SIM to a virtualized mobile network. In order to deliver such functionality as an “as-a-service” model, the process is broken down into three distinct stages. These stages include virtualization of telecommunication services, SIM provisioning/network connectivity/token distribution, and interconnection and cellular edge for policy enforcement. FIG. 6 is a diagram representing the three stages for providing zero trust mobile network-as-a-service.

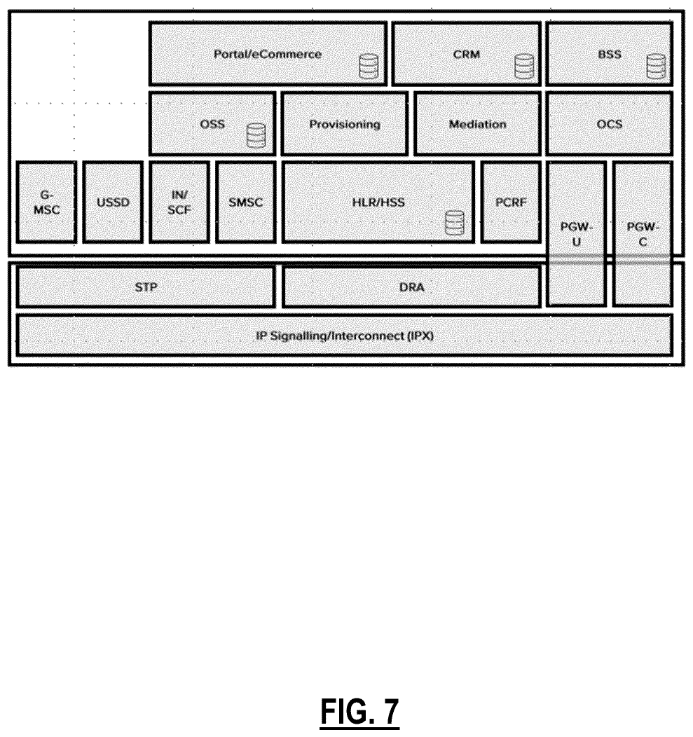

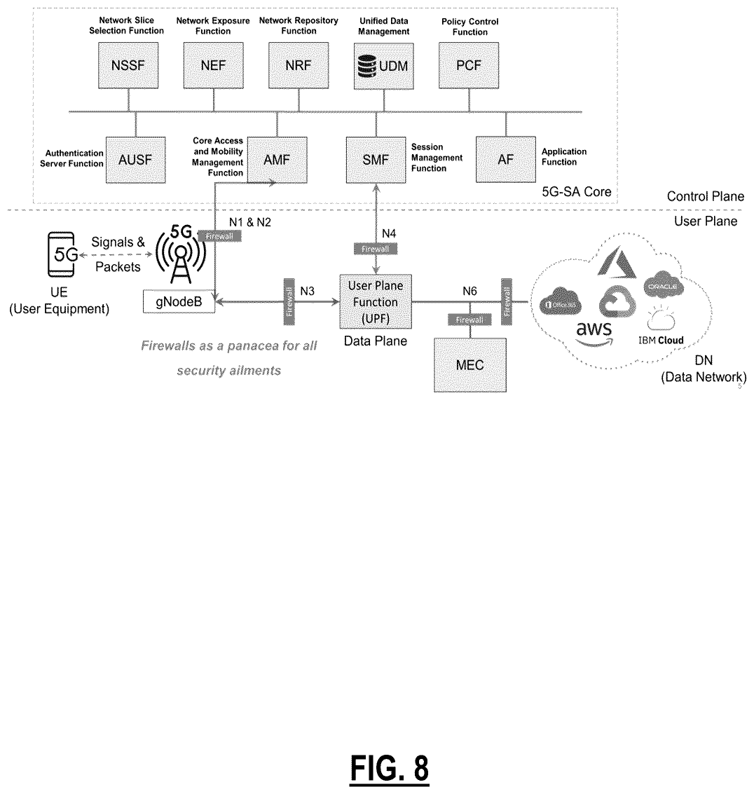

In the first stage 402, virtualization of telecommunication services includes creating a virtualized set of mobile telecommunication services. These services include, but are not limited to, the necessary components of a mobile network to move data packets, such as Core, Edge, Service layers as well as the necessary signaling interconnects to various networks such as, but not limited to, Internetworking Packet Exchange (IPX), General Radio Packet Service Roaming Exchange (GRX), Internet, local networks, etc. FIG. 7 is a representation of 4G services that can be virtualized when necessary to deliver data plane connectivity. FIG. 8 is a representation of 5G services that can be virtualized when necessary to deliver data plane connectivity. Delivering virtual services, on behalf of a customer requires the ability to build a decentralized packet switching platform, often named in the 4G world as a Packet Gateway (PGW) or within 5G the User Plane Function (UPF). Visualizing this packet switching function allows for automated and a distributed implementation, which subsequently allows for scalable and virtualized roll out, for customers on demand and here needed. The steps required for this are as outlined:
Distributed deployment of the virtual packet switching platform to the geographic need of the customer.
Interconnecting the virtual packet switching platform into the regional, local and global networks, including but not limited to, GRX and IPX.
Association of the authorized SIMs to leverage these new packet switches.
Distribution of SIM authority to “roam” or leverage other telco networks via best path available.
Distribution of routing paths across the mobile networks, optimized by Zero Trust Exchange.
Distribution of interconnection into the cloud-based systems 120 Zero Trust platform.

All of these steps are done to deliver the seamless path from SIM to application. The present virtualization of infrastructure/services can be utilized on any telecommunications and 3rd Generation Partnership Project (3GPP) service including public cellular networks, private cellular networks, extended cellular networks such as for satellite communications, and the like.

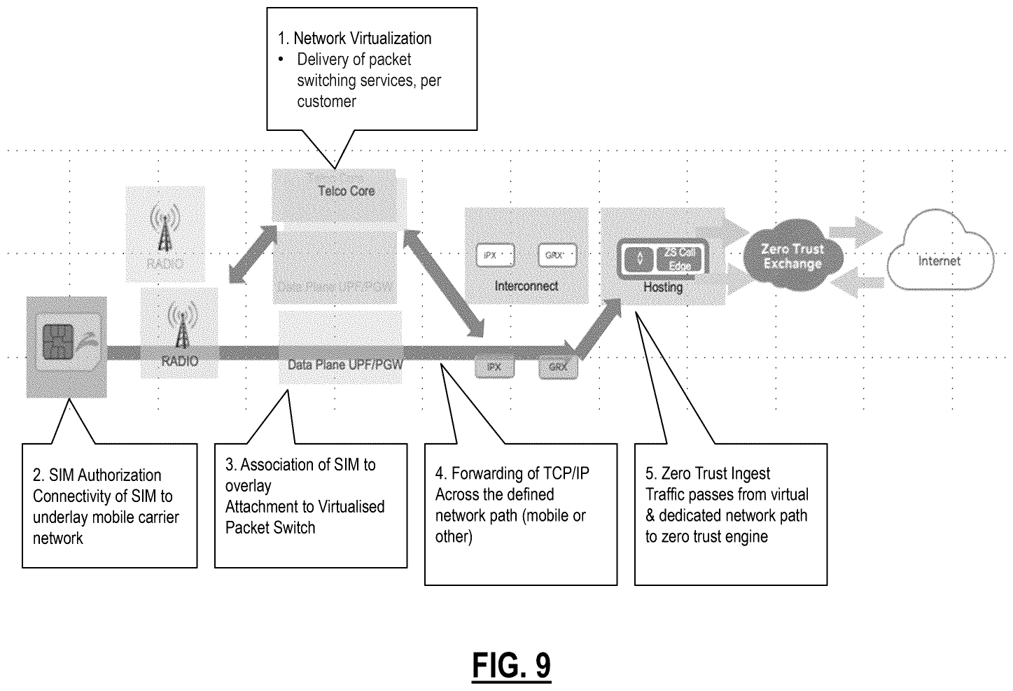

FIG. 9 is a flow diagram of a data path through virtualized infrastructure. This path includes steps of creating the network as a service, SIM authorization, Overlay association, Network path definition, and zero trust ingest.

By virtualizing the mobile network, the present systems can deliver a dedicated set of telecommunications services, solely for the requested entities traffic, allow protection and integrity to be mapped to an entities policy, i.e., the policy the entity utilizes within the cloud 120, and deliver a uniform service anywhere in the world on any carrier network. Further, the entity can be enabled to enforce policy to control which virtualized network service can be used and in which geographic location. That is, for example, granular policy options, with the inclusion of, but not limited to network, sim, operator, device, radio frequency, geo location, etc. allows for near-infinite possible combinations of controls. This allows consumers of the service to be highly prescriptive and uniform in the definition and use of access. Enforcement of control, based on these conditions, allow for a hyper specific zero trust policy implementation and thus protection of the SIM-connected entity in any country and on any mobile network. In one example, this control can include controlling a destination access of a SIM device because it has moved geographically closer, or further to a location.

In the second stage 404, SIM provisioning, network connectivity, and token distribution are performed. SIM provisioning ensures that SIMs are correctly provisioned to the correct virtualized service for each customer of the cloud 120. That is, the SIM must be provisioned for a specific service (virtualized mobile network) associated with its entity (enterprise, customer, etc.). In various embodiments, SIMs are allocated through a distribution of International Mobile Subscriber Identity (IMSI) ranges. This can be contemplated as a set of identifiable keys that allow a SIM to connect to a network. This key/IMSI must be shared with the correct owner as well as the network operator. By distributing IMSI ranges that are subdivided by entity under defined policies, the use of IMSIs can be restricted to the validated virtual infrastructure generated in the first stage 402. That is, the present systems and methods include assigning specific IMSI ranges to customers in order to steer their traffic to the correct virtualized mobile network. These SIMs/IMSIs can then be implemented on the entities virtual network, controlling how the services must be distributed. In various embodiments, the IMSI functionality of connectivity and roaming is enabled through IMSI roaming agreements or through Multi-IMSI, allowing the device to connect to a network which is not its “home network”. Integrating these methods fosters the seamless integration of the SIMs into the virtualized network from the first stage 402. Again, the various customers of the cloud 120 can be provided specified virtualized mobile networks on a per-customer basis, while the utilization of IMSI ranges allow the systems to correctly steer traffic to the customers network.

Within any mobile carrier network, roaming from a public to private, and beyond to additional networks is pivotal to the ability to deliver global entity function, connection, and service. The ability to achieve global roaming for public infrastructure is a foundational function for network connectivity and is empowered by the previously mentioned IMSI range allocation as well as network roaming agreements that allow the SIMs to move anywhere in any geographic location. The allocation of IMSI ranges to specific entities and the facilitation of network roaming form the foundation of the present invention. Utilizing the contextual information gathered from these functions enables intelligent connectivity decisions and allows this demonstrated context to be shared with other network planes. For example, a known IMSI+roaming approval, when used in a certain geographic region and mobile network, allows the systems to deliver a contextual allowance for access to the virtual mobile network. Further, context of traffic flows and behavior analysis allows for identity values that can be leveraged across a plurality of networks and organizations.

The present systems are further adapted to distribute cryptographic tokens to each SIM device of an entity in order to facilitate full end to end control of the connection from the SIM to the destination application. In various embodiments, these tokens are generated as intermediate tokens based on a trust provided to the consuming entity or submitted by the entity. By leveraging a centralized trust service to generate the intermediate token, the SIM can store and use the token as a point of trust validation throughout the network connection. This token serves as a critical component in ensuring secure communication, acting as a reliable reference point for validating trustworthiness. Moreover, the token can be provided to other processes within the host device, such as SSL/TLS encryption, secure boot processes, application-level security protocols, and other cryptographic operations. This approach ensures a consistent and reliable method of trust validation across different network interactions and internal processes, enhancing the overall security and integrity of the device's communications.

In the third stage 406, an interconnect and cellular edge for policy enforcement is provided. The point at which data traffic transitions from a mobile network to an external network—such as GRX, IPX, or the Internet—is often where the most significant network-related security issues arise. This juncture is critical because it involves moving data across different security domains, each with its own vulnerabilities and potential threats. Ensuring robust security measures at this transition point is essential to protect against unauthorized access, data breaches, and other malicious activities that can compromise the integrity and confidentiality of the data. Interchanges like GRX and IPX are not designed to apply any additional protection to traffic in transit. These interconnects primarily focus on facilitating the exchange of data between different network operators and service providers, without incorporating advanced security measures. As a result, the traffic passing through these interchanges can be vulnerable to various security threats, such as interception, eavesdropping, and tampering. The present invention proposes to programmatically define the path based on an entities policy rather than allowing the traffic to follow a default network path. In conjunction with policy-driven path steering, this method outlines the ability to apply a secure zero trust policy to all traffic that exits to external networks. By leveraging zero trust principles, every data packet is subject to stringent verification and authorization processes, regardless of its source or destination. This ensures that no traffic is trusted by default, and continuous validation of identity and context is enforced. This approach significantly enhances the security posture by mitigating the risks associated with traffic moving to less secure external networks, such as GRX, IPX, and the Internet, ensuring that all data remains protected throughout its journey.

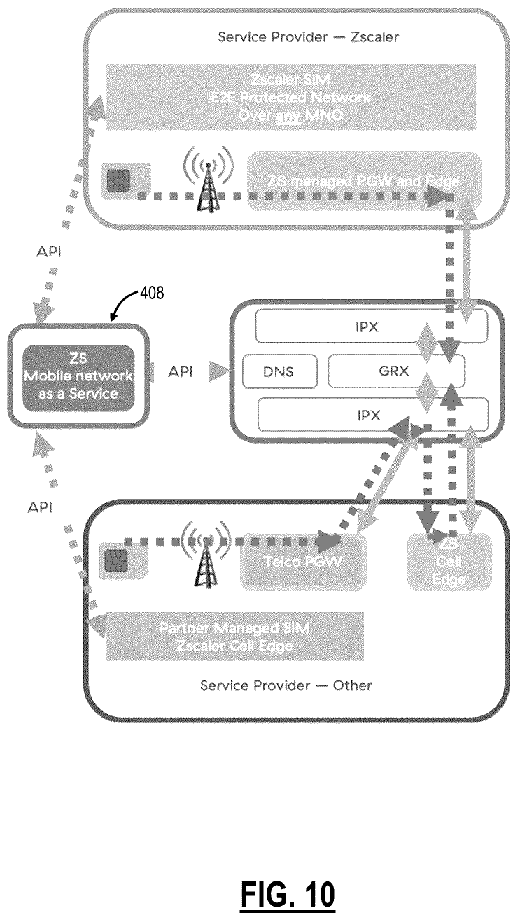

FIG. 10 is a flow diagram of an embodiment of the functionality of the present zero trust mobile network-as-a-service. The present invention allows for the implementation of the zero trust mobile network-as-a-service where each part of the connection from SIM deployment, cellular network provisioning, cellular infrastructure, path management and steering, optimization of interconnectivity, and secure access to services is granted, managed, and orchestrated by the zero trust as a service engine 408. In various embodiments, this service can be delivered via the two methods presented in FIG. 10. When the service provider is the cloud service provider, i.e., when the service provider is Zscaler, the provider of the cloud 120 and the plurality of security services described herein, end to end control of all services within the telecommunication chain ensures that all data packets pass through without any issue, risk, or lack of integrity. Alternatively, when the service provider is a third party cellular network provider, i.e., a telecommunications partner, the present service can still offer a plurality of services without the ability to control all parts of the path from end to end. That is, the service still relies on the underlying telecommunications partner to deliver services. A description of both of these flows, how the traffic flows through each of these examples, how it is controlled through each, and what infrastructure is virtualized is shown below for various scenarios.

### Scenario 1: Zscaler (Cloud 120) as the Cloud Service Provider

### SIM Deployment:

Step: Zscaler issues and provisions the SIM cards.
Control Mechanism: The SIM cards are preconfigured to authenticate and connect to Zscaler's network.
Infrastructure Virtualization: The SIM management and provisioning systems are virtualized to scale with demand.

### Cellular Network Provisioning:

Step: The SIM connects to the local cellular network.
Control Mechanism: Zscaler manages the provisioning profiles and ensures the cellular network is configured to route traffic through Zscaler's cloud 120.
Infrastructure Virtualization: Core cellular network functions may be virtualized to ensure seamless integration with Zscaler's cloud 120.

### Cellular Infrastructure:

Step: The cellular data traffic is routed to Zscaler's cloud 120 infrastructure.
Control Mechanism: Zscaler maintains control over the data path from the cellular network to its cloud 120, ensuring security policies are enforced.
Infrastructure Virtualization: Network functions such as gateways are virtualized to provide scalability and flexibility.

### Path Management and Steering:

Step: Zscaler manages the data paths to optimize performance and reliability.
Control Mechanism: Traffic is dynamically steered through the most optimal paths using Zscaler's global network.
Infrastructure Virtualization: Path optimization services are virtualized, allowing quick adjustments based on real-time network conditions.

### Optimization of Interconnectivity:

Step: Traffic is optimized for performance and security as it traverses Zscaler's network.
Control Mechanism: Zscaler applies optimization techniques such as caching, and QoS policies.
Infrastructure Virtualization: Optimization functions are virtualized to allow for efficient resource usage and scalability.

### Secure Access to Services:

Step: Data is securely delivered to the end services.
Control Mechanism: Zscaler enforces security policies, ensuring only authenticated and authorized access to services.
Infrastructure Virtualization: Security services such as gateways, intrusion prevention systems, and DLP are virtualized for flexible deployment.

### Scenario 2: Third-Party Cellular Network Provider

### SIM Deployment:

Step: Zscaler or the third-party provider issues and provisions the SIM cards.
Control Mechanism: The SIM cards are configured to authenticate and connect to the third-party cellular network.
Infrastructure Virtualization: The SIM management system may be partially virtualized by Zscaler but relies on the third-party provider for network access.

### Cellular Network Provisioning:

Step: The SIM connects to the third-party cellular network.
Control Mechanism: The third-party provider manages the network provisioning, but Zscaler may influence configuration via agreements or partnerships.
Infrastructure Virtualization: Core network functions are managed by the third-party provider and may or may not be virtualized.

### Cellular Infrastructure:

Step: Data traffic flows through the third-party provider's infrastructure.
Control Mechanism: Zscaler has limited control over the cellular infrastructure but ensures traffic is directed to its cloud for secure processing.
Infrastructure Virtualization: Virtualization depends on the third-party provider's infrastructure setup.

### Path Management and Steering:

Step: Zscaler manages the data paths once the traffic enters its cloud 120.
Control Mechanism: Traffic is directed from the third-party network to Zscaler's cloud 120, where Zscaler applies its path management mechanisms.
Infrastructure Virtualization: Zscaler's path

It will be appreciated that Zscaler is a cloud service provider that provides the cloud 120 and its functions as described herein. other embodiments can include any cloud 120 provider for virtualizing services as described in the present invention, and the examples of Zscaler shall be contemplated as non-limiting examples.

Leveraging this method and process, this architecture supports a comprehensive self-service model, enabling entities to easily subscribe to precisely what they need. This includes SIM provisioning, orchestration of virtual mobile infrastructure, and secure egress to the Internet. By adopting this flexible approach, organizations can tailor their mobile connectivity solutions to their specific requirements, ensuring seamless integration, enhanced security, and efficient management of resources. This model not only simplifies the subscription process but also enhances operational efficiency and scalability, allowing entities to focus on their core activities while relying on a robust and secure mobile infrastructure. The benefits to entities include near instant deployment of services, allowing for rapid provisioning and quick response to business needs. This architecture supports global deployment, enabling services to be implemented and managed in any location worldwide, ensuring broad accessibility and reach. Entities gain full API-driven control over network functions and exposure to the mobile network, allowing for seamless integration and automation. Additionally, the flexibility to bring your own carrier provides versatility and customization in carrier selection, ensuring that entities can tailor their mobile connectivity solutions to their specific requirements.

By utilizing the present zero trust mobile network-as-a-service, the systems can spin up a virtualized mobile network function wherever the customer needs it. Traditionally, if a user has a SIM from any telecommunications provider/carrier, if the user travels, the traffic will always be steered to where the provider is has their network. For example, if a user has an AT&T SIM and travels to Europe, the data will be transmitted back to the United States and egress locally in the United States. By utilizing the present systems and methods, this traditional architecture can be decoupled by the creation of an overlay function, i.e., the virtualized network, so that the customers traffic can be egressed wherever they are in that point in time regardless of which network they are on. Further, because the cloud 120 and its various functions become an integral part of the solution, end to end integrity checks, certificate checks, and other security functions can be performed.

In various embodiments, the present systems and methods can be contemplated as utilizing one or more telecommunications carriers as a type of transport layer. The cybersecurity of these telecommunications carriers is irrelevant because of the overlaying of the present virtual services. Thus, a virtual path is provided from a radio, which may belong to a third party, a customer, or the cloud provider (Zscaler), all the way until it connects to the cloud 120. In contrast, traditional methods include implementing a “bolt on” security function similar to a firewall.

It will be appreciated that the present zero trust mobile network-as-a-service can be generated and provided to customers of the cloud 120 via the various components associated with the cloud 120. That is, the various virtualized components of the virtual mobile network can be hosted on nodes, servers, etc. associated with the cloud 120.

### § 5.1 Process for Zero Trust Mobile Network-as-a-service

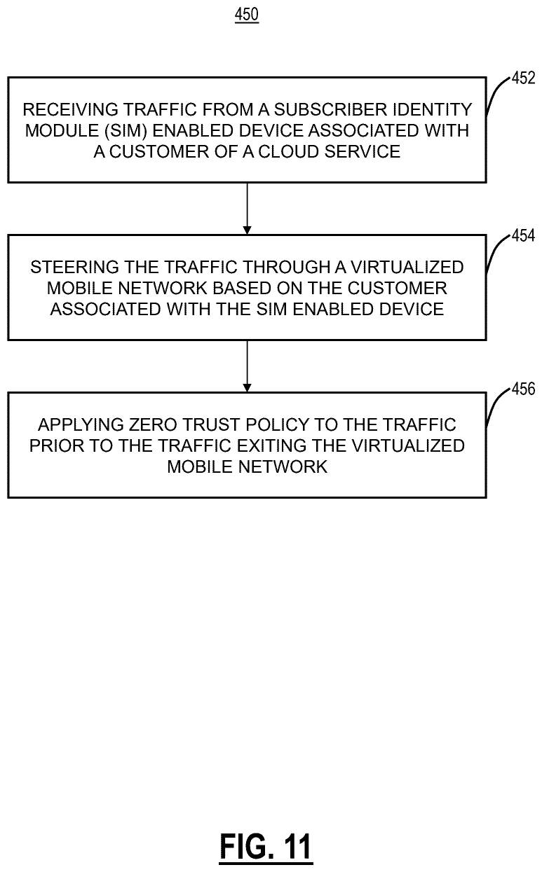

FIG. 11 is a flowchart of a process 450 for zero trust mobile network-as-a-service. The process 450 includes receiving traffic from a Subscriber Identity Module (SIM) enabled device associated with a customer of a cloud service (step 452); steering the traffic through a virtualized mobile network based on the customer associated with the SIM enabled device (step 454); and applying zero trust policy to the traffic prior to the traffic exiting the virtualized mobile network (step 456).

The process 450 can further include wherein the virtualized mobile network includes one or more virtualized components of a mobile network. The steps can include generating one or more virtualized mobile networks for one or more customers of the cloud service. Prior to the receiving, the steps can include provisioning the SIM of the SIM enabled device to a specific virtualized mobile network. The provisioning can include provisioning each of a plurality of SIMs of a plurality of devices to one of a plurality of specific virtualized mobile networks. Each of the plurality of specific virtualized mobile networks can be associated with a customer of the cloud service, wherein traffic from a device is navigated to a specific customer's virtualized mobile network based on the provisioning. Prior to the receiving, the steps can include distributing a cryptographic token to the SIM enabled device, wherein the SIM is adapted to store and use the cryptographic token as a point of trust validation throughout a connection to the virtualized mobile network.

### § 6.0 CONCLUSION

Those skilled in the art will recognize that the various embodiments may include processing circuitry of various types. The processing circuitry might include, but are not limited to, general-purpose microprocessors; Central Processing Units (CPUs); Digital Signal Processors (DSPs); specialized processors such as Network Processors (NPs) or Network Processing Units (NPUs), Graphics Processing Units (GPUs); Field Programmable Gate Arrays (FPGAs); or similar devices. The processing circuitry may operate under the control of unique program instructions stored in their memory (software and/or firmware) to execute, in combination with certain non-processor circuits, either a portion or the entirety of the functionalities described for the methods and/or systems herein. Alternatively, these functions might be executed by a state machine devoid of stored program instructions, or through one or more Application-Specific Integrated Circuits (ASICs), where each function or a combination of functions is realized through dedicated logic or circuit designs. Naturally, a hybrid approach combining these methodologies may be employed. For certain disclosed embodiments, a hardware device, possibly integrated with software, firmware, or both, might be denominated as circuitry, logic, or circuits “configured to” or “adapted to” execute a series of operations, steps, methods, processes, algorithms, functions, or techniques as described herein for various implementations.

Additionally, some embodiments may incorporate a non-transitory computer-readable storage medium that stores computer-readable instructions for programming any combination of a computer, server, appliance, device, module, processor, or circuit (collectively “system”), each potentially equipped with one or more processors. These instructions, when executed, enable the system to perform the functions as delineated and claimed in this document. Such non-transitory computer-readable storage mediums can include, but are not limited to, hard disks, optical storage devices, magnetic storage devices, Read-Only Memory (ROM), Programmable Read-Only Memory (PROM), Erasable Programmable Read-Only Memory (EPROM), Electrically Erasable Programmable Read-Only Memory (EEPROM), Flash memory, etc. The software, once stored on these mediums, includes executable instructions that, upon execution by one or more processors or any programmable circuitry, instruct the processor or circuitry to undertake a series of operations, steps, methods, processes, algorithms, functions, or techniques as detailed herein for the various embodiments.

While the present disclosure has been detailed and depicted through specific embodiments and examples, it is to be understood by those skilled in the art that numerous variations and modifications can perform equivalent functions or yield comparable results. Such alternative embodiments and variations, which may not be explicitly mentioned but achieve the objectives and adhere to the principles disclosed herein, fall within its spirit and scope. Accordingly, they are envisioned and encompassed by this disclosure, warranting protection under the claims associated herewith. Additionally, the present disclosure anticipates combinations and permutations of the described elements, operations, steps, methods, processes, algorithms, functions, techniques, modules, circuits, etc., in any manner conceivable, whether collectively, in subsets, or individually, further broadening the ambit of potential embodiments.

What is claimed is:

1. A method comprising steps of:
receiving traffic from a Subscriber Identity Module (SIM) enabled device associated with a customer of a cloud service;
steering the traffic through a virtualized mobile network based on the customer associated with the SIM enabled device; and
applying zero trust policy to the traffic prior to the traffic exiting the virtualized mobile network.

2. The method of claim 1, wherein the virtualized mobile network comprises one or more virtualized components of a mobile network.

3. The method of claim 1, wherein the steps comprise generating one or more virtualized mobile networks for one or more customers of the cloud service.

4. The method of claim 1, wherein prior to the receiving, the steps comprise provisioning the SIM of the SIM enabled device to a specific virtualized mobile network.

5. The method of claim 4, wherein the provisioning comprises provisioning each of a plurality of SIMs of a plurality of devices to one of a plurality of specific virtualized mobile networks.

6. The method of claim 5, wherein each of the plurality of specific virtualized mobile networks is associated with a customer of the cloud service, and wherein traffic from a device is navigated to a specific customer's virtualized mobile network based on the provisioning.

7. The method of claim 1, wherein prior to the receiving, the steps comprise distributing a cryptographic token to the SIM enabled device, wherein the SIM is adapted to store and use the cryptographic token as a point of trust validation throughout a connection to the virtualized mobile network.

8. A non-transitory computer-readable medium comprising instructions that, when executed, cause one or more processors to perform steps of:
receiving traffic from a Subscriber Identity Module (SIM) enabled device associated with a customer of a cloud service;
steering the traffic through a virtualized mobile network based on the customer associated with the SIM enabled device; and
applying zero trust policy to the traffic prior to the traffic exiting the virtualized mobile network.

9. The non-transitory computer-readable medium of claim 8, wherein the virtualized mobile network comprises one or more virtualized components of a mobile network.

10. The non-transitory computer-readable medium of claim 8, wherein the steps comprise generating one or more virtualized mobile networks for one or more customers of the cloud service.

11. The non-transitory computer-readable medium of claim 8, wherein prior to the receiving, the steps comprise provisioning the SIM of the SIM enabled device to a specific virtualized mobile network.

12. The non-transitory computer-readable medium of claim 11, wherein the provisioning comprises provisioning each of a plurality of SIMs of a plurality of devices to one of a plurality of specific virtualized mobile networks.

13. The non-transitory computer-readable medium of claim 12, wherein each of the plurality of specific virtualized mobile networks is associated with a customer of the cloud service, and wherein traffic from a device is navigated to a specific customer's virtualized mobile network based on the provisioning.

14. The non-transitory computer-readable medium of claim 8, wherein prior to the receiving, the steps comprise distributing a cryptographic token to the SIM enabled device, wherein the SIM is adapted to store and use the cryptographic token as a point of trust validation throughout a connection to the virtualized mobile network.

15. A server comprising:
one or more processors and memory comprising instructions that, when executed, cause the one or more processors to:
receive traffic from a Subscriber Identity Module (SIM) enabled device associated with a customer of a cloud service;
steer the traffic through a virtualized mobile network based on the customer associated with the SIM enabled device; and
apply zero trust policy to the traffic prior to the traffic exiting the virtualized mobile network.

16. The server of claim 15, wherein the virtualized mobile network comprises one or more virtualized components of a mobile network.

17. The server of claim 15, wherein the instructions further cause the processor to generate one or more virtualized mobile networks for one or more customers of the cloud service.

18. The server of claim 15, wherein prior to the receiving, the instructions further cause the processor to provision the SIM of the SIM enabled device to a specific virtualized mobile network.

19. The server of claim 18, wherein the provisioning comprises provisioning each of a plurality of SIMs of a plurality of devices to one of a plurality of specific virtualized mobile networks.

20. The server of claim 19, wherein each of the plurality of specific virtualized mobile networks is associated with a customer of the cloud service, and wherein traffic from a device is navigated to a specific customer's virtualized mobile network based on the provisioning.
